(19) United States
(12) Patent Application Publication
(10) Pub. No.: US 2026/0262626 A1
(43) Pub. Date: Sep. 10, 2026

(54) AGRICULTURAL SPRAYER LINK ASSEMBLY

(71) Applicant: Deere & Company, Moline, IL (US)

(72) Inventor: Jacob W. Petersen, Ankeny, IA (US)

(21) Appl. No.: 19/072,211

(22) Filed: Mar. 6, 2025

(51) Int. Cl. A01M 7/00

(52) U.S. Cl. CPC A01M 7/0075; A01M 7/0057

(57) ABSTRACT

A link assembly for a wing assembly having a variable length inner wing link. Actuation of a driver provides a force that is transmitted by the link assembly to displace the wing assembly between folded and unfolded positions. As the wing assembly moves to the unfolded position, a linear length of the inner wing link increases, which facilitates increases in the lengths of the moment arms of the inner wing link and driver. The inner wing link and fold cylinder can continue to increase in length after the wing assembly reaches the unfolded position, allowing further displacement of a common link pivot at which the inner wing link and driver are pivotally coupled to move, which, along with the increased moment arms, can decrease the loads exerted on the link assembly and driver. Additionally, the inner wing link length decreases as the wing assembly is displaced to the folded position.

### FIELD OF THE DISCLOSURE

The present disclosure generally relates to agricultural sprayers, and, more specifically, to link assemblies for foldable wing assemblies of agricultural sprayers.

### BACKGROUND

Agricultural sprayers are utilized in conjunction with agricultural work vehicles to distribute flowable materials, such as spray solutions, over crop fields. An agricultural work vehicle, which is typically used to move the agricultural sprayer through fields during application of the flowable materials to crops, can be part of the agricultural sprayer, or be a separate vehicle. Often agricultural sprayers have boom wings that are cantilevered out from a central frame that can be coupled to the agricultural work vehicle. Such boom wings can be configured to allow agricultural sprayers to travel over crops in a manner that avoids potentially damaging contact by the agricultural sprayer to the crops. Further, such a cantilevered configuration can be sized to accommodate agricultural sprayers dispensing, with each pass of the agricultural sprayers, flowable materials to crops across relatively large areas of the field. Thus, at least some larger agricultural sprayers can have relatively expansive widths across the length of the boom wings, including, for example, widths that can approach, or exceed, forty meters, among other widths.

### SUMMARY

The present disclosure may comprise one or more of the following features and combinations thereof.

In one implementation of the present disclosure, a foldable boom assembly is provided for an agricultural sprayer, the foldable boom assembly including a wing assembly that can have an inner wing that is pivotally coupled to an outer wing at a wing fold pivot, and a driver having a first end that can be pivotally coupled to the inner wing. The foldable boom assembly can also include a variable length inner wing link having a first end that is pivotally coupled to the inner wing, and an outer wing link having a first end that is pivotally coupled to the outer wing. Additionally, the foldable boom assembly can include a common link pivot that can be pivotally coupled to each of a second end of the driver, a second end of the variable length inner wing link, and a second end of the outer wing link. Further, a length of the variable length inner wing link can change as the outer wing is pivotally displaced about the wing fold pivot and relative to the inner wing.

In one example of the implementation, the outer wing can have an angular orientation at the first position that is around 180 degrees different than the angular orientation of the outer wing at the second position, and the first position can correspond to an unfolded position of the wing assembly, and the second position can correspond to a folded position of the wing assembly. Additionally, according to another example, the outer wing can have an angular orientation at the first position that is around 180 degrees different than the angular orientation of the outer wing at the second position, and the first position can correspond to a unfolded position of the wing assembly, and the second position can correspond to an folded position of the wing assembly. Further, according to another example of the implementation, the driver can be a fold cylinder, and the variable length inner wing link can be configured to accommodate a continued extension of a length of the fold cylinder and the length of the variable length inner wing link after the wing assembly is at the unfolded position.

In another example of the implementation, the driver can be a fold cylinder, and the length of the variable length inner wing link can accommodate the fold cylinder attaining a full stroke. Further, an example of the implementation can include the common link pivot being configured to move from a first side of the wing fold pivot to a second side of the wing fold pivot, and the variable length inner wing link, and not the driver, can pass over a wing fold pivot axis of the wing fold pivot. Additionally, in another example of the implementation, the outer wing, the inner wing, the variable length inner wing link, and the outer wing link can comprise a four-bar linkage that can generally maintain a diamond shape as the outer wing is displaced relative to the inner wing. Further, an example of the implementation can include the length of the variable length inner wing link increases as the displacement of the outer wing places the foldable wing assembly in an unfolded position. Further, with such an example, the length of the variable length inner wing link can decrease as the displacement of the outer wing places the foldable wing assembly in a folded position. Additionally, an example of the implementation can also include the variable length inner wing link being configured to control, in at least one direction, an adjustment in the length of the variable length inner wing link. Another example of the implementation can include the variable length inner wing link being an unpowered hydraulic or pneumatic cylinder.

According to another implementation, a link assembly is provided for a foldable boom assembly of an agricultural sprayer. The link assembly can include a driver and a four-bar linkage. The four-bar linkage can include an outer wing of a wing assembly of the foldable boom assembly, and an inner wing of the wing assembly, the inner wing being pivotally coupled to at least the outer wing at a wing fold pivot to accommodate a pivotal displacement of the outer wing relative to the inner wing about a wing fold pivot axis of the wing fold pivot. Additionally, the four-bar linkage can include an inner wing link, a first end of the inner wing link being pivotally coupled to at least the inner wing. Further, the inner wing link can be adjustable between a first length and a second length, the first length being larger than the second length. The four-bar linkage can also include an outer wing link that can be pivotally coupled to at least the outer wing. The inner wing link can be configured to extend toward the first length in response to a first actuation by the driver that facilitates a transmission of a first force to at least a portion of the four-bar linkage that displaces the outer wing from a first position to a second position. Further, the outer wing can have an angular orientation at the first position that is around 180 degrees different than the angular orientation of the outer wing at the second position. Additionally, the inner wing link can be configured to collapse to the second length in response to a second actuation by the driver that facilitates a transmission of a second force to at least a portion of the four-bar linkage that displaces the outer wing from the second position to the first position. The four-bar linkage can also be configured for the inner wing link, and not the driver, to cross over a center of the wing fold pivot axis as the outer wing moves between the first position and the second position.

In one example of the implementation, the first length can be configured to increase a length of a first moment arm of the inner wing link and a second moment arm of the driver, and the inner wing link can be configured to continue to extend to attain the first length while the outer wing is at the second position. Additionally, another example, can include the inner wing link being configured to control an adjustment of a length of the inner wing link as the inner wing link moves toward at least one of the first length and the second length using at least one of a hydraulic fluid, a positive pressure in a chamber of the inner wing link, or a biasing element. A further example of the implementation can include the driver being a fold cylinder, and the first length of the inner wing link can accommodate the fold cylinder attaining a full stroke.

Additionally, according to another implementation, a method is provided for folding and unfolding a wing assembly for an agricultural sprayer. The method can include displacing, by a first actuation of a driver, a second end of the driver from a first side of a wing fold pivot to a second side of the wing fold pivot, an outer wing and an inner wing of the wing assembly being pivotally coupled at the wing fold pivot. Additionally, a first end of the driver can be pivotally coupled to the inner wing. The method can also include increasing an adjustable length of an inner wing link at least as the second end of the driver is displaced to the second side of the wing fold pivot to increase a length of both a first moment arm of the inner wing link and a length of a second moment arm of the driver. Further, a first end of the inner wing link can be pivotally coupled to the inner wing, and a second end of the inner wing link can be pivotally coupled to the second end of the driver. Additionally, an outer wing link can be pivotally displaced with the displacement of the second end of the driver to the second side of the wing fold pivot, a first end of the outer wing link being pivotally coupled to the outer wing, and a second end of the outer wing link being pivotally coupled to the second end of the driver. The outer wing can also be pivotally displaced from a first position to a second position by the first actuation of the driver, the outer wing having an angular orientation at the first position that is around 180 degrees different than the angular orientation of the outer wing at the second position.

An example of the implementation can include displacing, by a second actuation of the driver, the second end of the driver from the second side to the first side of the wing fold pivot; decreasing the adjustable length of the inner wing link at least as the second end of the driver is displaced to the first side of the wing fold pivot; pivotally displacing the outer wing link with the displacement of the second end of the driver to the first side of the wing fold pivot; and pivotally displacing the outer wing from the second position to the first position by the second actuation of the driver. Further, according to another example, increasing the adjustable length of the inner wing link can further comprise moving the inner wing link, but not the driver, across a wing fold pivot axis of the wing fold pivot. Additionally, an example of the implementation can include the first position of the outer wing corresponding to a fully folded position of the wing assembly, and the second position of the outer wing corresponding to a fully unfolded position of the wing assembly. Another example of the implementation can include further increasing a length of a moment arm of the inner wing link and a length of a moment arm of the driver when the wing assembly is in the fully unfolded position.

These and other features of the present disclosure will become more apparent from the following description of the illustrative implementations.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a rear perspective view of an exemplary agricultural sprayer with a boom assembly during a spraying operation.

FIG. 2 illustrates a side perspective view of an exemplary agricultural sprayer with the boom assembly folded for at least non-spraying transport.

FIG. 3 illustrates a top view of a portion of an agricultural sprayer boom assembly showing a left-side wing assembly in an unfolded, field-working position.

FIG. 4 illustrates a view similar to FIG. 3 but showing the left-side wing assembly in a at a position between the unfolded and folded positions.

FIG. 5 illustrates a side perspective view of a link assembly coupled to adjacent ends of an inner wing and an outer wing of a wing assembly.

FIG. 6 illustrates a simplified schematic of an exemplary variable length inner wing link for a link assembly.

FIG. 7 illustrates a top, partial cross-sectional view of an exemplary wing assembly at a folded position.

FIG. 8 illustrates a simplified two-dimensional top view representation of a portion of a link assembly having a variable length inner link at which the wing assembly is at the folded position.

FIG. 9 illustrates the wing assembly shown in FIG. 7 at a partially unfolded position.

FIG. 10 illustrates the representation of the wing assembly shown in FIG. 8 at the partially unfolded position.

FIG. 11 illustrates the wing assembly shown in FIG. 7 at the unfolded position.

FIG. 12 illustrates the representation of the wing assembly shown in FIG. 8 at the unfolded position.

Corresponding reference numerals are used to indicate corresponding parts throughout the several views.

### DETAILED DESCRIPTION

While the concepts of the present disclosure are susceptible to various modifications and alternative forms, specific implementations thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one implementation,” “an implementation,” “an illustrative implementation,” etc., indicate that the implementation described may include a particular feature, structure, or characteristic, but every implementation may or may not necessarily include that particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements or orderings. However, it should be appreciated that such specific arrangements and orderings may not be required. Rather, in some implementations, such features may be arranged in a different manner or order than shown in the illustrative figures. Additionally, the inclusion of a structural or method feature in a particular figure is not meant to imply that such feature is required in all implementations and, in some implementations, may not be included or may be combined with other features.

Systems for folding sprayer boom assemblies can be configured to reduce a transport width of the boom assemblies while also seeking to attain structural integrity during field operations. Often, the configuration of foldable wing assemblies of boom assemblies can experience relatively high torques at least when unfolding, which can necessitate increased counterbalance valve pressures and added mass to associated components of the wing assemblies. Yet, despite such enhancements, such wing assemblies may not sufficiently address the increasing dynamic loads associated with increasing wing assembly widths, including as the corresponding boom assemblies exceed, for example, thirty meters in width, among other widths.

Implementations of the subject disclosure therefore provide a variable length link assembly for use with the wing assemblies of boom assemblies for agricultural machinery, including, for example, sprayer booms. The link assembly can be configured to utilize at least a driver in connection with a four-bar linkage that can include a variable length inner wing link. Additionally, the link assembly can be configured to facilitate an at least near 180-degree rotation in an angular orientation of an outer wing for the folding and unfolding of the associated wing assembly.

The variable length inner wing link can be configured to be extendable in terms of a linear length of the inner wing link at least when the wing assembly is moved to an unfolded position. By having an extendable length, the inner wing link can, when selectively extended, provide a relatively large component to link assembly. Moreover, by extending the length of the inner wing link as the inner wing link moves to, and reaches, a position associated with the wing assembly being at an unfolded position, a moment arm of the inner wing link, as well as a moment arm of the associated driver, can both be increased in length. For example, according to certain implementations, an increase in the length of the inner wing link can accommodate a common link pivot to which the inner wing link, driver, and an outer wing link of the link assembly are each pivotally coupled being displaced past, and away from, a wing fold pivot that pivotally couples at least the inner and outer wings of the wing assembly together. By extending the length of the inner wing link to facilitate the common link pivot being moved past the wing fold pivot, the length of moment arms of the inner wing link and driver can be increased. Such increases in the lengths of the moment arms can contribute to a decrease in the loads on the driver and inner wing link, as well as the loads on other portions of the link assembly, including the associated couplings and pins. Such decreases in the loads on the driver and link assembly can also, compared to at least traditional systems, accommodate a decrease in the size of the driver, pins, and/or at least some linkages of the link assembly used for the displacement of the wing assembly between the folded and unfolded positions.

The ability to selectively expand the length of the inner wing link can accommodate the driver not moving over the center of the wing fold pivot axis. By avoiding such over-center movement, implementations of the subject disclosure may avoid using an over-center position for locking lock or holding the wing assembly at the unfolded position, as well as avoid bending the driver or link assembly that may otherwise be associated with such over-center movement.

The variable length inner wing link can also be configured for the length of the inner wing link to be selectively reduced as the outer wing is displaced with the wing assembly being moved from the unfolded position to the folded position. Moreover, the inner wing link can be reduced to a collapsed length as the wing assembly is displaced to the folded position. The ability to attain a reduced, collapsed length at least when the wing assembly is at the folded position can minimize or reduce the area or space occupied by the inner wing link. Moreover, the ability of the inner wing link to be reduced to a smaller length when the wing assembly is at the folded position, as was as the reduction of loads accommodating usage of a smaller driver, as previously discussed, can assist in minimizing, including reducing, the size of the area occupied by the link assembly and driver. Such reductions in the space requirements for at least the collapsed inner wing link and driver can facilitate the outer wing being moved into relatively close proximity to the inner wing when the wing assembly is in the folded position. Thus, such a configuration of the link assembly and driver can facilitate the link assembly and driver occupying a relatively compact envelope or area at which the link assembly and driver extend between, and into spaces within one or both of the inner and outer wings. Further, by the link assembly and/or driver being able to be contained within a relatively small area when the wing assembly is in a folded position, an angular orientation of the outer wing can change by at least nearly, or, 180 degrees when the wing assembly is displaced between the folded and unfolded positions.

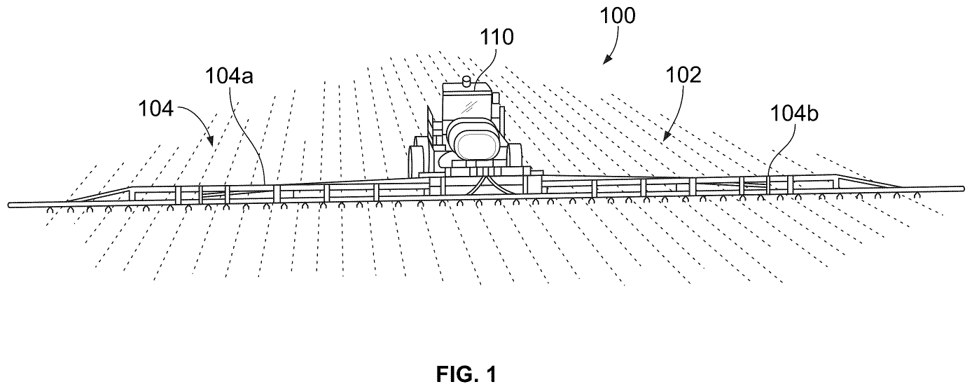

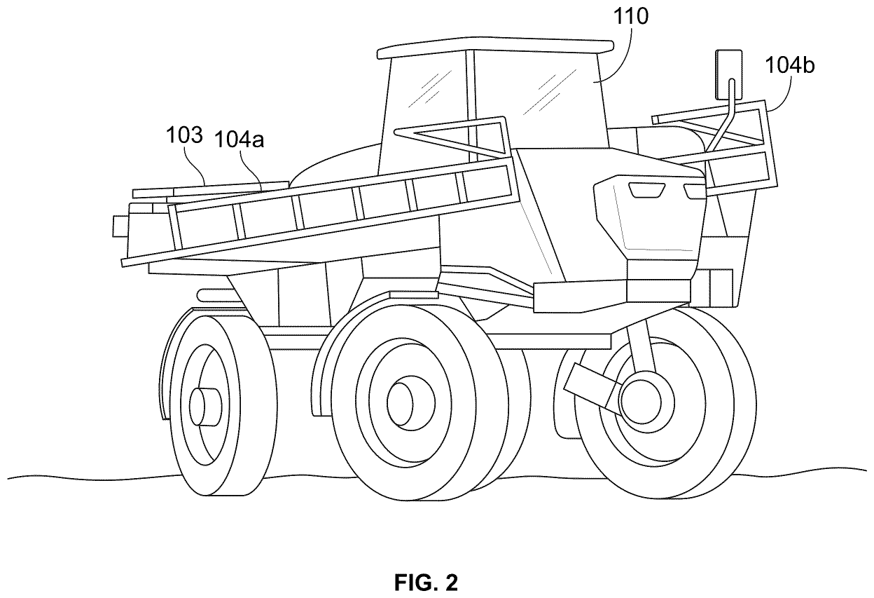

FIGS. 1 and 2 illustrate an exemplary agricultural sprayer 100 for agricultural spraying operations. While a particular agricultural sprayer 100 is shown in FIGS. 1 and 2, the agricultural sprayer 100 can have a variety of other configurations. Generally, the agricultural sprayer 100 supports a boom assembly 102, which can include first and second wing assemblies 104a, 104b (each generally referred to herein as wing assembly 104). When the boom assembly 102 is unfolded such that each of the first and second wing assemblies 104a, 104b are unfolded, the unfolded wing assemblies 104a, 104b can extend a substantial distance in opposing directions to either side of the agricultural sprayer 100. The width across at least the unfolded first and second wing assemblies 104a, 104b, and thus across the corresponding boom assembly 102, can be relatively extensive so that the boom assembly 102, including associated nozzles that extend from the wing assemblies 104a, 104b, can distribute flowable materials across to a relatively large portion of the field, including onto crops in the field. A variety of different types of agricultural work vehicles can be used as the agricultural work vehicle 110, including, but not limited to, self-propelled, autonomous, and semi-autonomous vehicles that are adapted for at least forward movement over a field.

The boom assembly 102 can have a variety of configurations, including, for example, with respect to the directions of pivotal displacement of at least portions of the wing assemblies 104a, 104b as the wing assemblies 104a, 104b are displaced between the folded and unfolded positions. For example, the exemplary agricultural sprayer 100 shown in FIG. 2 depicts a boom assembly 102 configured for the first and second wing assemblies 104a, 104b to be pivotally displaced about one or more generally vertically extending axes. According to such an implementation, at least a portion of the first and second wing assemblies 104a, 104b can be pivotally displaced between the folded and unfolded positions in directions that are generally parallel to the adjacent ground surface. Conversely, according to other implementations, the boom assembly 102 can be configured for the first and second wing assemblies 104a, 104b to be pivotally displaced about one or more other, or different, axes, including, for example, axes that extend in a generally horizontal direction. Thus, for example, according to certain implementations, at least a portion of the first and second wing assemblies 104a, 104b can be raised and lowered relative to the adjacent ground surface as the first and second wing assemblies 104a, 104b are pivotally displaced between the folded and unfolded positions.

In the illustrated implementation, the boom assembly 102 of the agricultural sprayer 100 can be generally symmetrical across a width of the agricultural sprayer 100 in a direction generally perpendicular to a direction of forward travel of the agricultural sprayer 100. Accordingly, while discussion herein may be presented with respect to only one side of the boom assembly 102, and, moreover, generally to a wing assembly 104, it will be understood that such discussions can apply to either or both the first and second wing assembly 104a, 104b.

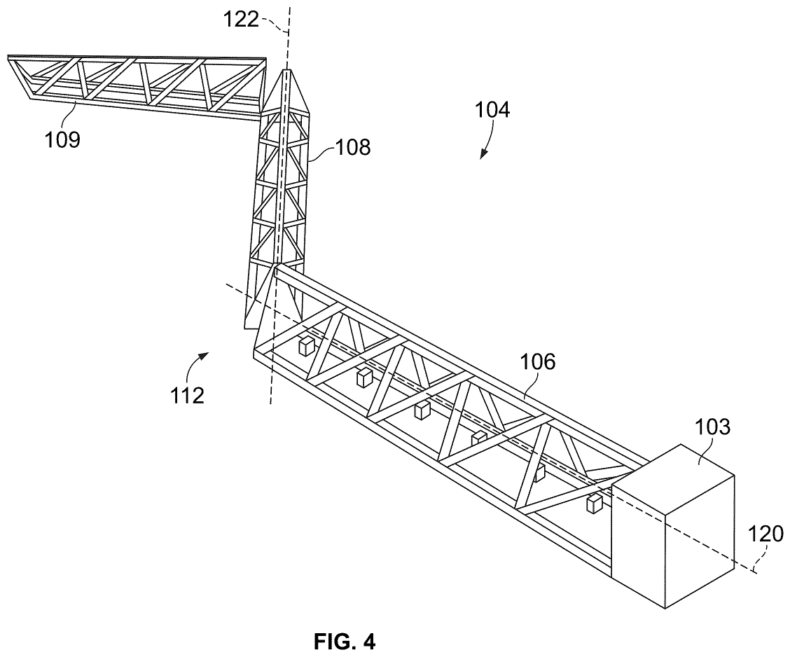

As seen in at least FIGS. 2, 3 and 4, each of the first and second wing assemblies 104a, 104b can be foldable such that at least the overall width or wingspan of the boom assembly 102, as well as of corresponding width across each of the first and second wing assemblies 104a, 104b, can be reduced. For example, as seen in at least FIG. 4, the illustrated wing assembly 104 can include a plurality of wings, including an inner wing 106, an outer wing 108, and a breakaway wing 109, the outer wing 108 being, when the wing assembly 104 is in the unfolded position, farther from the associated agricultural work vehicle 110 than the inner wing 106.

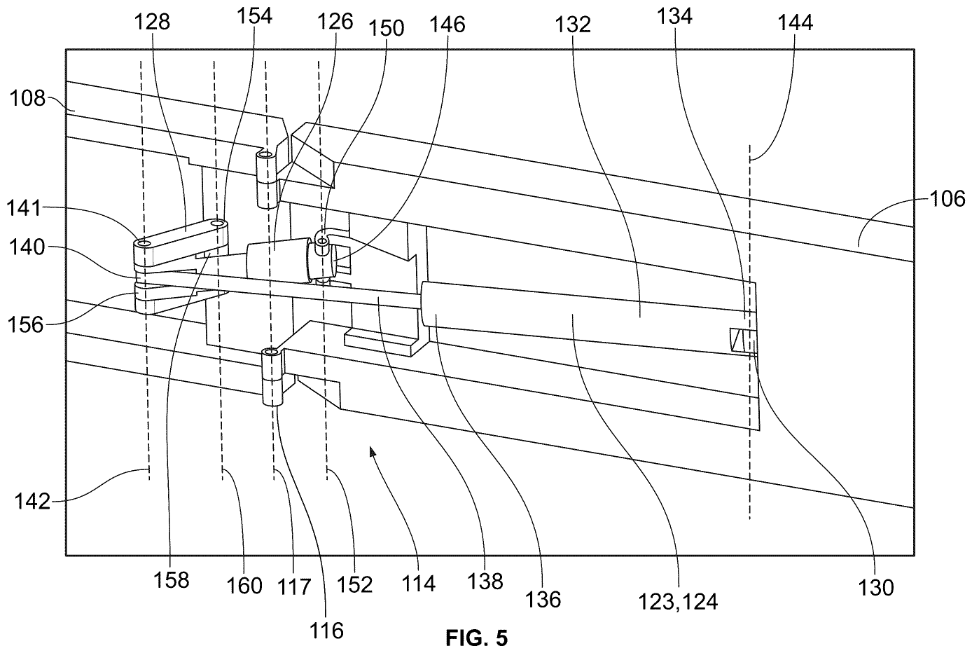

The inner and outer wings 106, 108 can be pivotally coupled to each other at a primary or wing fold pivot 116 that is generally located at, or around, a joint 112 between the inner and outer wings 106, 108. The joint 112 can be configured to accommodate pivotal displacement of the outer wing 108 relative to the inner wing 106 about an outer wing fold pivot axis 117 (FIG. 5) at the wing fold pivot 116. Moreover, the outer wing 108 can also be pivotally coupled to the inner wing 106 such that the outer wing 108 can be pivotally displaced relative to the inner wing 106 as the wing assembly 104 is moved between the folded and unfolded positions. The wing fold pivot axis 117 can, according to certain implementations, be generally perpendicular, or non-parallel, to a forward direction of travel of the agricultural sprayer 100, as well as generally perpendicular, or non-parallel, to the adjacent ground surface upon which the agricultural sprayer 100 travels.

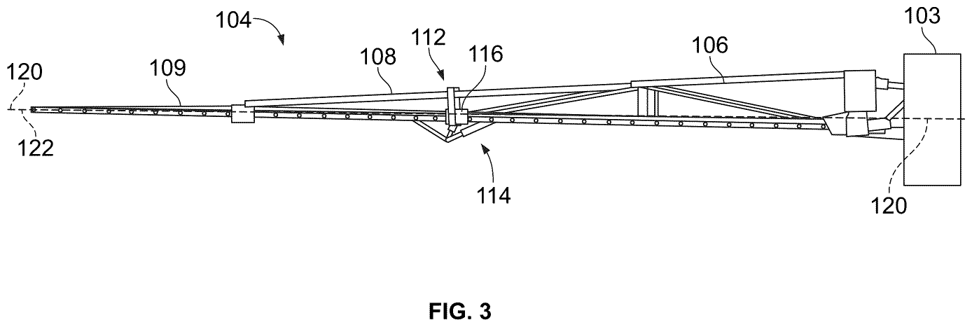

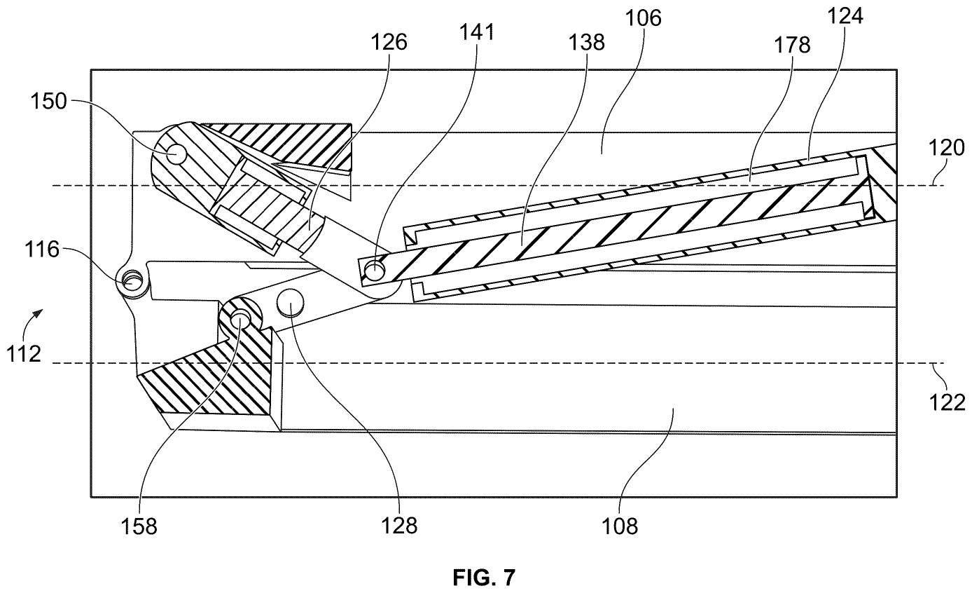

As seen in at least FIG. 3, when the wing assembly 104 is at the unfolded position, the outer wing 108 can be at an outwardly directed field-working position away from a center frame assembly 103 (FIG. 2). Moreover, as seen in FIG. 3, when the wing assembly 104 is at the unfolded position, the outer wing 108 can be generally aligned with the inner wing 106 so that the wing assembly 104 is generally fully unfolded. In such a situation, a central axis 118 of the wing assembly 104 can longitudinally extend through both the inner and outer wings 106, 108 in a direction that is generally perpendicular to a direction of forward travel of the agricultural sprayer 100. Further, as discussed below, a link assembly 114 can be configured to accommodate an angular orientation of the outer wing 108 being rotated about 180 degrees when the wing assembly 104 is displaced between the unfolded and folded positions. For example as seen in FIG. 7, when the wing assembly 104 is at the folded position, an outer wing central axis 122 of the outer wing 108 can be generally parallel to, and offset from, an inner wing central axis 120 of the inner wing 106, particularly when compared to the relative positions of the axes 120, 122 when the wing assembly 104 is unfolded, as shown in FIG. 3.

As seen in at least FIG. 5, the wing assembly 104 can include the link assembly 114, which can be used to assist in a transmission of forces used to displace of the outer wing 108 relative to the inner wing 106 in connection with the wing assembly 104 being displaced between the folded and unfolded positions. According to certain implementations, the link assembly 114 can include a variable length inner wing link 126 and an outer wing link 128, and can be coupled to a driver 123. As discussed below, according to certain implementations, the inner wing 106, the outer wing 108, the inner wing link 126, and the outer wing link 128 can be coupled directly or indirectly together in a manner that can provide a four-bar linkage having a variable length link (e.g., the variable length inner wing link 126), and which is displaced by the selective, controlled actuation of the driver 123.

A variety of different types of actuatable devices can be utilized as the driver 123, including, for example, a hydraulic or pneumatic cylinder, an electric actuator, or a ball-screw drive, among other types of drivers. In the illustrated implementation the driver 123 is a fold cylinder 124 that can be a single or double-acting hydraulic or pneumatic cylinder, that can include a cylinder body 132 having a first end 134 and a second end 136. The first end 134 of the cylinder body 132 can be pivotally coupled, including, for example, via a pin, to the inner wing 106 at an inner wing pivot 130. Such a pivotable coupling between the fold cylinder 124 and the inner wing 106 can be configured to accommodate the fold cylinder 124 being pivotably displaced relative to at least the inner wing 106 about an inner wing axis 144 at the inner wing pivot 130. According to certain implementations, the inner wing axis 144 can be generally perpendicular, or non-parallel, to both the forward direction of travel of the agricultural vehicle 110 and the ground surface on which the agricultural vehicle 110 travels. Further, the inner wing axis 144 can be generally parallel to, and offset from, the wing fold pivot axis 117. Alternatively, according to other implementations, rather than the first end 134 of the cylinder body 132 being pivotally coupled to the inner wing 106, the fold cylinder 124 can instead be pivotally coupled to the inner wing 106 via a trunnion mount, among other manners of pivotally coupling the fold cylinder 124 to the inner wing 106.

The fold cylinder 124 can also include a rod 138 that is selectively displaceable to extend different lengths away from the second end 136 of the cylinder body 132 via a flow of a hydraulic fluid or gas, among other fluids, into and/or out of a chamber 178 of the cylinder body 132. An end 140 of the rod 138 opposite to the first end 134 of the cylinder body 132 can be pivotally coupled to a common link pivot 141 such, for example, via a pin. Such coupling of the rod 138, and thus the foldable cylinder 124, can accommodate pivotal displacement of the fold cylinder 124 at the common link pivot 141 about a common link axis 142. As seen in FIG. 5, according to the certain implementations, the common link axis 142 can be generally parallel to the both the wing fold pivot axis 117 and the inner wing axis 144.

Selective operation of the fold cylinder 124, such as, for example, via a controlled supply or removal of the fluid from the chamber 178, can displace at least a portion of the rod 138 within the chamber 178 in a manner that can adjust the length of the portion of the rod 138 that extends, or does not extend, from the second end 136 of the cylinder body 132, thereby allowing for controlled adjustment in the linear length of the fold cylinder 124. Such controlled variation of the length of the fold cylinder 124 can be used to selectively facilitate an actuation of the fold cylinder 124. Moreover, such controlled flow of fluid into, or out of, the chamber 178 can be translated into linear actuation of the fold cylinder 124 that can facilitate a pivotal displacement of outer wing 108 relative to the inner wing 104 about the wing fold pivot axis 117 as the wing assembly 104 is displaced between the folded and unfolded positions.

The inner wing link 126 is a variable length body, including, for example, a variable length assembly. Moreover, the inner wing link 126 is variable with respect to at least a linear length of the inner wing link 126 between opposing first and second end 146, 148 of the inner wing link 126. The adjustable length of the inner wing link 126 is configured to optimize load management and facilitate an over-pivot action, but not an over-center action, that can minimize the load on the fold cylinder 124 and/or on one or more components of the link assembly 114.

The variation in the length of the inner wing link 126 can be controlled at least with respect to a rate of change in the length of the inner wing link 124 in one or both directions, such as, for example, with respect to an increase and/or decrease in the linear length of the inner wing link 126. Such controlled variation in the length of the inner wing link 126 can assist with controlling the motion of the link assembly 114 and/or the associated loads. Thus, the variable length of the inner wing link 126 is configured to allow the inner wing link 126 to at least extend, lengthwise, in a controlled manner as the inner wing link 126 is pivotally displaced with the wing assembly 104 being displaced from the unfolded position to the folded position. Additionally, or alternatively, the variation of the length of the inner wing link 126 can be controller as at least the length as the inner wing link 126 is reduced as the inner wing link 126 is pivotally displaced with the wing assembly 104 being displaced from the unfolded position to the folded position. The inclusion of a variable length inner wing link 126 can enable shorter strokes of the fold cylinder 124, which can assist in the link assembly being more compact so as to fit within the envelope of space between the folded inner and outer wings 106, 108, as discussed above. As discussed below, a shorter stroke of the fold cylinder 124 and the ability of the inner wing link 126 to change length can at least assist with the common link pivot 141 reaching a position relative to at least the wing fold pivot 116 when the wing assembly 104 is at the unfolded position that can increase the length of moment arms of the inner wing ling 126 and the fold cylinder 124, which can significantly reduce loads on at least the fold cylinder 124 and the link assembly 114. Additionally, as discussed above, by being variable in length, the inner wing link 126 can have a relatively compact envelope to enable the link assembly 114 and fold cylinder 124 to occupy a space between, and within into one or both, of the inner and outer wings 106, 108 when the wing assembly 104 is in the folded position in a manner that can facilitate the angular orientation of the outer wing 108 changing by, or around, 180 degrees when the wing assembly 104 is displaced between the unfolded and folded positions.

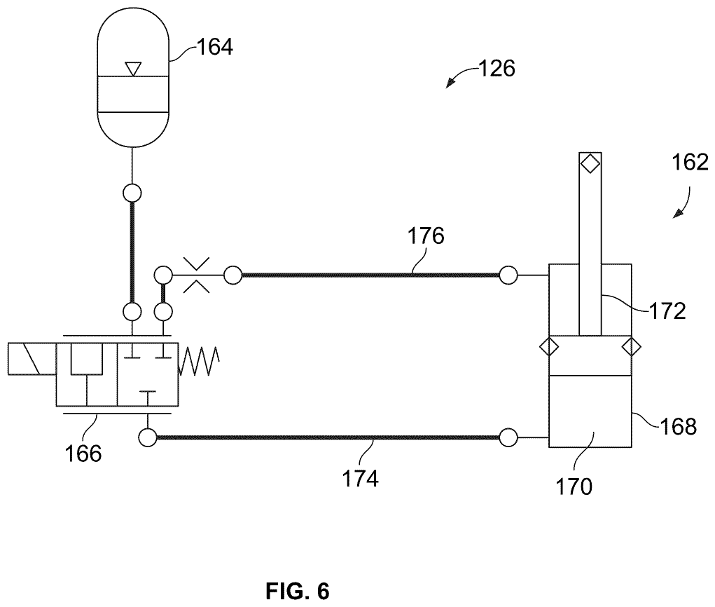

Unlike the folder cylinder 124, the inner wing link 126 can be unpowered such that variations in the length of the inner wing link 126, as well as the pivotal displacement of the inner wing link 126, can be in reaction to, or otherwise selectively controlled by, the operation of the fold cylinder 124. According to such implementations, the inner wing link 126 can be configured to provide a force that can assist in biasing the inner wing link 126 to at least one of an extended or a retracted length, and/or can assist in selectively maintaining the inner wing link 126 at the extended and/or retracted length. For example, according to certain implementations, the inner wing link 126 can be an unpowered hydraulic or pneumatic cylinder, including, for example, a cylinder that utilizes a self-contained fluid system that can include an accumulator 164 having charged fluid or gas, as generally shown in FIG. 6. Such a self-controlled fluid system can be used to control a rate of adjustment or change of the length of the inner wing link 126 in at least one direction, or, alternatively, in both directions. Additionally, the charged fluid or gas of the accumulator 164 can assist in providing a damper that prevents sudden changes in the length of the inner wing link 126. According to certain implementations, the gas or fluid provided by the accumulator 164 can be charged, for example, to around 50 pounds per square inch (PSI).

With respect to the exemplary inner wing link 126 implementation shown in FIG. 6, the inner wing link 126 can include a cylinder 162 having a housing 168 that defines at least a portion of a chamber 170 that encases a portion of a piston rod 172. A linear displacement of piston rod 172 within chamber 170 can be facilitated in response to movement of at least the outer wing 108 via an actuation of the fold cylinder 124, thereby causing a change in the length in the inner wing link 126. As the piston rod 172 is displaced relative to at least the chamber 170, a flow of fluid, such as, for example, a hydraulic oil or gas can flow along a first and/or second fluid passageway 174, 176 into, or out of, the accumulator 164. The flow of hydraulic fluid between the chamber 170 and the accumulator 164 can be used to control a positive pressure being exerted on, or against, the piston rod 172 in the chamber 170 as the length of the inner wing link 126 changes. Such a flow of hydraulic fluid can thus assist in controlling the rate of change in the length of the inner wing link 126 in at least one, if not both, directions in response to at least a change in the position of the outer wing 108, as well as assist in maintaining a length of the inner wing link 126 at least when the outer wing 108 is at the folded and unfolded positions, as well as positions therebetween.

As also seen in FIG. 6, the self-contained fluid circuit can also include a valve 166, such as, for example, a two position, three-way valve, that can control, including selectively stop, the flow of hydraulic fluid between the accumulator 164 and the chamber 170. At least the ability of the valve 166 to stop the flow of hydraulic fluid between the accumulator 164 and the chamber 170 can assist in holding and/or preventing a change in the length of at least the inner wing link 126. For example, in the event a displacement of the outer wing 108 is to stop while the wing assembly 104 is being moved between the folded or unfolded position, a signal can be communicated to the valve 166 to stop the flow of hydraulic fluid into, and/or out of, the chamber 170, so as to assist in maintaining the current length and/or position of at least the inner wing link 126 and/or the wing assembly 104.

While FIG. 6 illustrates an exemplary implementation of the inner wing link 126, the inner wing link 126 can have a variety of other configurations in addition to, or in lieu of, being a hydraulic or pneumatic cylinder 162. For example, according to certain implementations, rather than utilizing a hydraulic fluid, the chamber 170 can include one or more biasing elements, such as, for example a spring or a series of springs that can bias the piston rod 172 to one of an extended position or a retracted position or length relative to at least the housing 168. Additionally, according to certain implementations, rather that having a piston rod 172, the inner wing link 126 can include a plurality of telescopically arranged rods that may be biased by one or more biasing elements to one of the extended or retracted positions or lengths. However, with each of the various implementations, the inner wing link 126 can remain variable with at least respect to the linear length of the inner wing link 126.

As seen in at least FIG. 5, in the illustrated implementation, the first end 146 of the inner wing link 126 can be pivotally coupled, for example via a pin, at an inner link pivot 150 to the inner wing 106. The first end 146 of the inner wing link 126 can thus be pivotally displaced at the inner link pivot 150 about an inner link axis 152 that can be generally parallel to at least the inner wing axis 144. Further, as also shown in FIG. 5, the inner link pivot 150 can be positioned in closer proximity to the outer wing 108 than the inner wing pivot 130. Further, according to certain implementations, while the wing fold pivot 116 can be generally at, or around, an outer end of the inner wing 106, the inner link pivot 150 is at least literally offset from the wing fold pivot 116 in a direction generally toward the vehicle 110 or away from the outer end of the inner wing 106. As also seen in FIG. 5, the second end 148 of the inner wing link 126 is coupled to the common link pivot 141 such that the inner wing link 126 can also be pivotally displaced about the common link axis 142.

Turning to the outer wing link 128, the outer wing link 128 can assist with coordinated movement of the outer wing 108 relative to the inner wing 106 during folding and unfolding operations of the wing assembly 102. A first end 154 of the outer wing link 128 can be pivotally coupled to the outer wing 108 at an outer link pivot 158 such that the outer wing link 128 and the outer wing 108 can be pivotally displaced at least relative to each other about an outer link axis 160. The outer link axis 160 can be generally parallel to, and offset from, at least the common link axis 142. Additionally, a second end 156 of the outer wing link 128 can be pivotally coupled to the common link pivot 141 such that the outer wing link 128 is also pivotally displaceable about the common link axis 142. Further, the outer wing link 128 can be positioned and configured for a transmission of forces between at least the fold cylinder 124 and the outer wing 108 to assist with providing structural integration throughout movement of the wing 108 between the folded and unfolded positions. Moreover, the outer wing link 128 can work in conjunction with at least the variable length inner wing link 126 to maintain an alignment and balance of loads efficiently across the wing assembly 104.

The inner wing 106, outer wing 108, inner wing link 126, and outer wing link 128 can provide a variable length four-bar linkage that can create some form of a diamond shape as the wing assembly 104 is displaced between the folded and unfolded positions, and in which the driver 123, in this example, the fold cylinder 124, provides an associated control linkage. With respect to such a four-bar linkage, the inner wing 106 can generally serve as a fixed component of the four-bar linkage system. Further, as discussed above, the inner wing 106 can be pivotally coupled to the inner wing link 126 at the inner link pivot 150 and to the first end 134 of the fold cylinder 124 at the inner wing pivot 130. These connections can assist with the inner wing 108 providing a stable base during the folding and unfolding of the wing assembly 104.

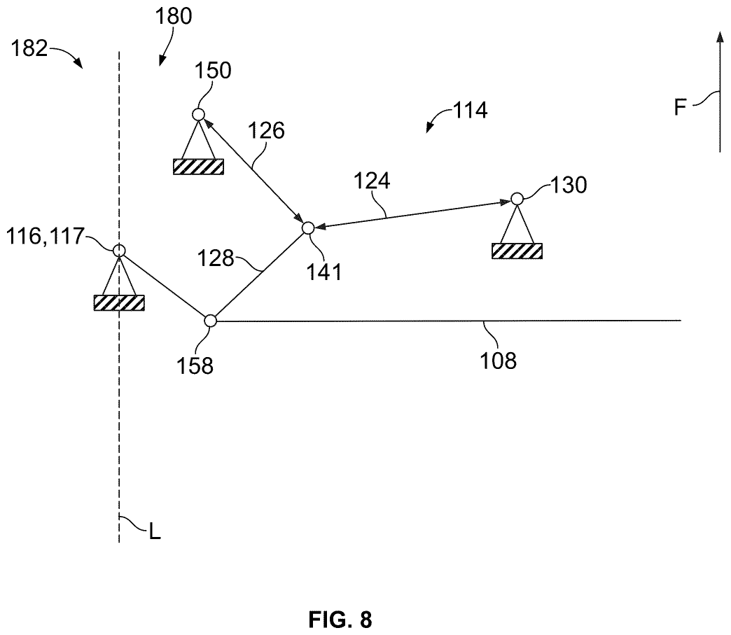

FIG. 7 illustrates a top, partial cross-sectional view of the exemplary wing assembly 104 at a folded position, which is also represented by the simplified schematic shown in FIG. 8. As seen in both FIGS. 7 and 8, the common link pivot 141 can serve as a central connecting point that allows relative pivoting of the inner wing link 126, the outer wing link 128, and the fold cylinder 124 at the common link pivot 141. Further, as previously discussed, and as seen in FIG. 7, with the outer wing 108 in the folded position, the outer wing central axis 122 is generally parallel to, and offset from, the inner wing central axis 120. As also shown in FIGS. 7 and 8, with the wing assembly 104 in the folded position, the common link pivot 141 is positioned at a first side 180 of the wing fold pivot 116, as generally indicated in FIG. 8 by the position of the common link pivot 141 relative to a reference line (“L”) that extends through the wing fold pivot 116 in a direction that is generally parallel to a forward direction of travel (as generally indicated by “F” in FIG. 8) of the agricultural sprayer 100. Thus, in this example, when the common link pivot 141 is at the first side of the wing fold pivot 116, the common link pivot 141 is on the same side of the wing fold pivot 116 as at least the inner wing pivot 130. Additionally, with the wing assembly 104 at the folded position, the variable length inner wing link 126 can be at a first, collapsed or retracted length with respect to a length generally between the first and second ends 146, 148 of the inner wing link 126.

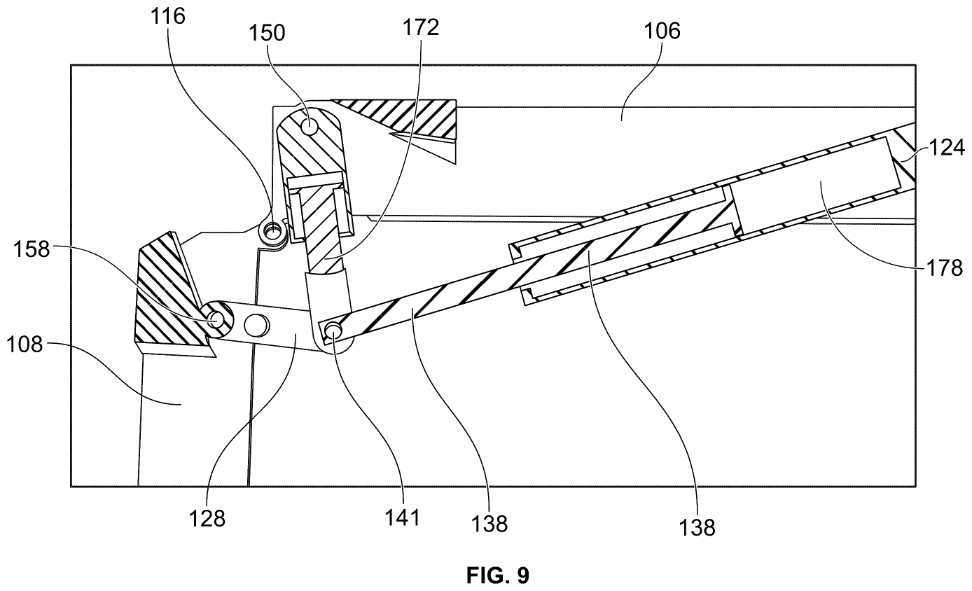

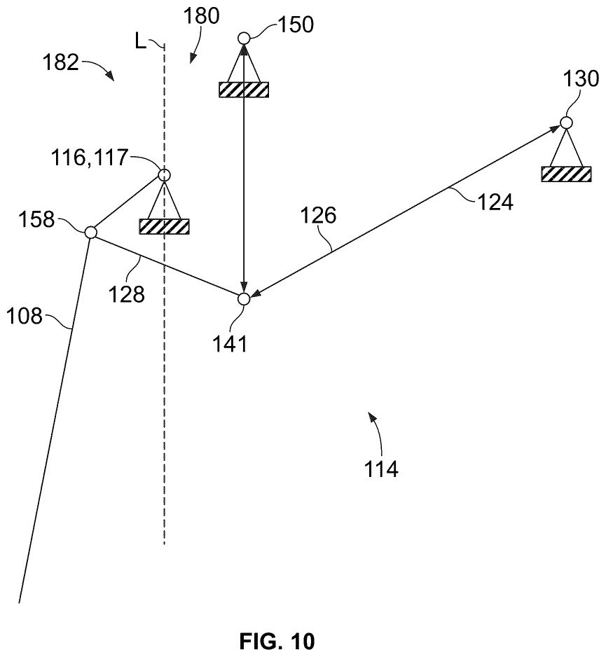

FIG. 9 illustrates a top, partial cross-sectional view of the exemplary wing assembly 104 at a partially unfolded position that is between the folded and unfolded positions, which is also represented by the simplified schematic shown in FIG. 10. In this illustrated example, the outer wing 108 has been moved approximately 90° from the folded position of the wing assembly 104 shown in at least FIG. 8. As further seen, at this illustrated exemplary stage or moment of the unfolding process of the wing assembly 104, the common link pivot 141 remains positioned on the first side 180 of the wing fold pivot 116. Further, the pivotal displacement of the outer wing 108, which can be facilitated by the actuation, including extension, of the fold cylinder 124, can coincide with the linear length of the inner wing link 126 being extended from the first length shown in at least FIG. 7 to a second length, the second length being longer than the first length.

As the wing assembly 104 continues to be pivotally displaced to the unfolded position, the linear length of the variable length inner wing link 126 can continue to increase until the wing assembly 104 reaches the unfolded position. Thus, at the unfolded position, the linear length of the variable length inner wing link 126 can reach a third, extended length that is greater than both the first and second lengths mentioned above with respect to at least FIGS. 8 and 10. Additionally, according to least certain implementations, the third, extended length of the inner wing link 126 can correspond to a length that allows the fold cylinder 124 to generally be fully extended, such as, for example, obtain a full stroke in terms of the travel capabilities of the piston within the chamber 178 of the fold cylinder 124 that is coupled to the rod 138, and/or a full extension of the rod 138. By being expandable from at least the collapsed length to the extended length, the inner wing link 126 can, at least when the wing assembly is in the unfolded position, selectively provide the link assembly 114 with the benefit a larger component sized system in at least terms of the load capacity the link assembly 114 can handle or be subjected to, while still providing smaller size benefits in terms of at least the link assembly 114 being foldable, with the reduction in length of the inner wing link 126, to occupy a relatively compact envelope between, and within, the folded inner and outer wings 106, 108.

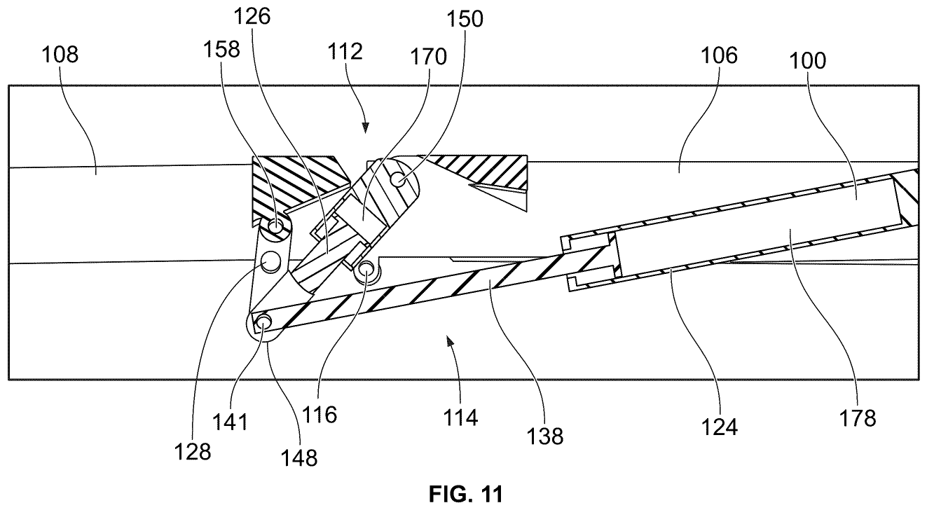

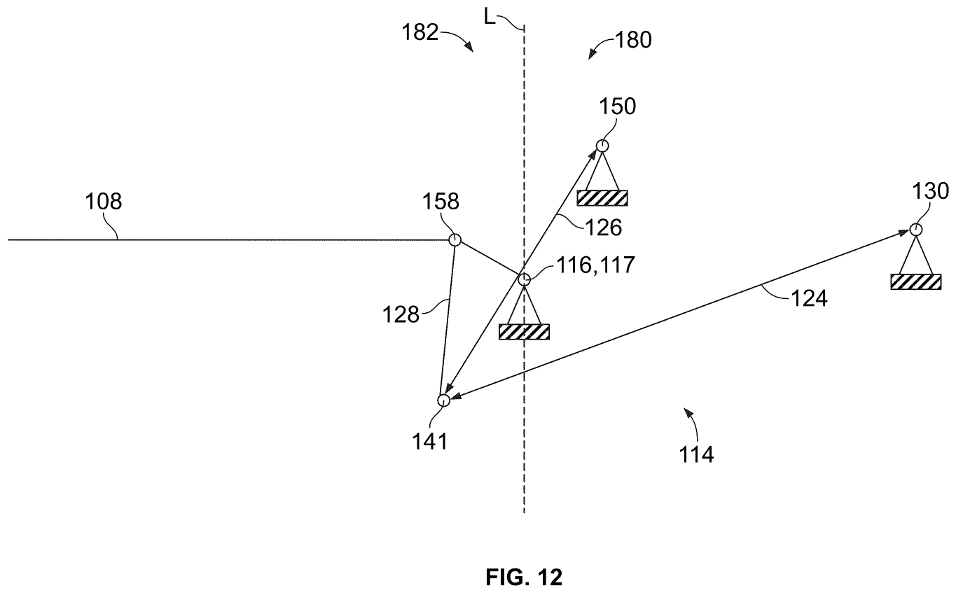

As seen by at least FIGS. 11 and 12, in the illustrated implementation, with the wing assembly 104 at the unfolded position, the common link pivot 141 has moved past the wing fold pivot 116 and at a second side 182 of the wing fold pivot 116, the second side 182 being opposite to the first side 180 of the wing fold pivot 116. Such positioning of the common link pivot 141 is as also illustrated by the position of the second side 182 relative to the previously mention reference line (“L”).

Such movement of the common link pivot 141 past the wing fold pivot 116 however does not involve the fold cylinder 124, including, for example, the rod 138 of the fold cylinder 124, moving to a position at which the fold cylinder 124 moves to, or over, the center of the wing fold pivot axis 117. Indeed, as seen at least in each of FIGS. 8, 10, and 12, during displacement of the wing assembly 104 between the folded and unfolded positions, the fold cylinder 124 does not move to, or over, the wing fold pivot axis 117. Thus, movement of the common link pivot 141 relative to at least the wing fold pivot 116 may instead involve movement of the fold cylinder 124 moving to, or past, the wing fold pivot axis 117 as the common link pivot 141 moves between first and second sides 180, 182 of the wing fold pivot 116.

Unlike the fold cylinder 124, the adjustable length of the inner wing link 126 can accommodate the inner wing link 126 moving over, and past, the center of the wing fold pivot axis 117. The inner wing link 126 being moved to a position past the wing fold pivot axis 117 that can assist in decreasing the loads on the inner wing link 126. Such a decrease in loads can enhance the ability of the inner wing link 126 to support the wing 106 when the wing 106 is in the unfolded position. Moreover, the resulting decrease in loads by moving the inner wing link 126 past the wing fold axis 117 can enhance the support provided by at least the inner wing link 126 in selectively retaining the wing 106 in the unfolded position as the wing 106 experiences various forces and changes in dynamics while performing an agricultural operation, such as spraying flowable materials. Such positioning of the inner wing link 126 can also place the inner wing link 126 in a position at which the inner wing link 126 and the fold cylinder 124 can work together to at least assist in maintaining the wing assembly 104 in the unfolded position.

According to such an implementation, as the wing 106 is moved to the unfolded position, the length of the inner wing link 126 and fold cylinder 124 continue to increase, thereby resulting in an increase in the corresponding moment arms of the inner wing link 126 and fold cylinder 124. Additionally, when the wing assembly 104 reaches the unfolded position, at least the expandable length of the inner wing link 126 can allow the fold cylinder 124 to continue to extend until the fold cylinder 124 is extended to attain a full stroke for the fold cylinder 124. Such continued extension of the fold cylinder 124 and inner wing link 126 can further increase the lengths of the fold cylinder 124 and the inner wing link 126, thereby increasing the size of the corresponding moment arms for each of the fold cylinder 124 and the inner wing link 126. Again, such increases in the lengths of the moment arms can be translated into a reduction in loads on at least the fold cylinder 124 and the inner wing link 126, among other components of the link assembly 114, thereby allowing for use of smaller components for the fold cylinder 124, inner wing link 126, and other associated components, including pins, among others.

Such decreases in the loads exerted on the fold cylinder 124 and components of the linkage assembly 114, among other components, attained by implementations of the subject disclosure can apply to wing assemblies 104, and associated boom assemblies 102, having various lengths. Thus, despite possible ever-increasing changes in the designed widths of wing assemblies 104, and for the associated boom assemblies 102, the ability of implementations of the subject disclosure to reduce the loads on the fold cylinder 124, among other drivers 123, as well as the link assembly 114 can minimize, if not prevent, increases in the sizes, including weights, of the drivers 123 and link assemblies 114 that can handle such wider boom assemblies 102, as well as assist in such drivers 123 and link assemblies 114 being able to maintain such larger wing assemblies 104 in at least unfolded positions. Additionally, despite such increases in wing assembly widths 104, by being able to use relatively smaller drivers and components of the link assembly 114, implementations of the subject disclosure can assist in the driver 123 and the link assembly 114 occupying a relatively compact envelope when the wing assembly 104 is in the folded position, as previously discussed.

While the foregoing example provided in FIGS. 8-12 is discussed in terms of the wing assembly 104 being displaced from the folded position to the unfolded position, a similar process, but in reverse, can occur with respect to the displacement of the wing assembly 104 from the unfolded position to the folded position. For example, as the wing assembly 104 is moved from the unfolded position shown in FIG. 12 to the folded position shown in FIG. 8, the length of the inner wing link 126 is decreased as the common pivot 141 is displaced from the second side 182 to the first side 180 of the wing fold pivot 116.

Additionally, while the foregoing examples are discussed in terms of the inner wing link 126 being variable in length, alternatively, according to other implementations, the outer wing link 128 can instead be variable in length while the inner wing link 126 maintains a generally static length. Similar to the variable inner wing link 126, the outer wing link 128 can be variable in length to at least increase the size of the moment arm between the coupling of the fold cylinder 124 at the common link pivot 141 and the wing fold pivot 116 so as to decrease the loads on the fold cylinder 124 and other portions of the link assembly 114.

According to such implementations, the outer wing link 128 can have a configuration similar to that discussed above with respect to the variable length inner wing link 126 such that the outer wing link 128 can be extended, in a controlled manner, including, for example, with respect to a rate of change in the length of the outer wing link 128, between extended and retracted, or collapsed, lengths. Thus, for example, the outer wing link 128 can have a configuration similar to that discussed above with respect to FIG. 6 wherein the outer wing link 128 can include a hydraulic or pneumatic cylinder that is fluidly coupled to an accumulator, and in which a valve is used to control the positive pressure within the cylinder. However, similar to the variable length inner wing link 126, the length of the variable length outer wing link 128 can be controlled in at least one, if not both, directions, in a variety of other manners, including via use of one or more springs that can bias a position of the piston rod 172, or other similar component of the outer wing link 128. However, unlike the variable length inner wing link 126, the variable length outer wing link 128 can be at the longer, extended length when the wing 106 is at the folded position, and the smaller, collapsed, or retracted length when the fold cylinder is at the unfolded position.

While the disclosure has been illustrated and described in detail in the foregoing drawings and description, the same is to be considered as exemplary and not restrictive in character, it being understood that only illustrative implementations thereof have been shown and described and that all changes and modifications that come within the spirit of the disclosure are desired to be protected.

1. A foldable boom assembly for an agricultural sprayer, the foldable boom assembly comprising:
a wing assembly having an inner wing pivotally coupled to an outer wing at a wing fold pivot;
a driver having a first end pivotally coupled to the inner wing;
a variable length inner wing link having a first end pivotally coupled to the inner wing;
an outer wing link having a first end pivotally coupled to the outer wing; and
a common link pivot pivotally coupling a second end of the driver, a second end of the variable length inner wing link, and a second end of the outer wing link,
wherein a length of the variable length inner wing link changes as the outer wing is pivotally displaced about the wing fold pivot and relative to the inner wing.

2. The foldable boom assembly of claim 1, wherein the length of the variable length inner wing link is a first length when the outer wing is at a first position relative to the inner wing, and wherein the length of the variable length inner wing link is a second length when the outer wing is at a second position relative to the inner wing, the first length being different than the second length.

3. The foldable boom assembly of claim 2, wherein the outer wing has an angular orientation at the first position that is around 180 degrees different than the angular orientation of the outer wing at the second position, wherein the first position corresponds to an unfolded position of the wing assembly, and wherein the second position corresponds to an folded position of the wing assembly.

4. The foldable boom assembly of claim 3, wherein the driver is a fold cylinder, and wherein the variable length inner wing link is configured to accommodate a continued extension of a length of the fold cylinder and the length of the variable length inner wing link after the wing assembly is at the unfolded position.

5. The foldable boom assembly of claim 1, wherein the driver is a fold cylinder, and wherein the length of the variable length inner wing link accommodates the fold cylinder attaining a full stroke.

6. The foldable boom assembly of claim 1, wherein the common link pivot is configured to move from a first side of the wing fold pivot to a second side of the wing fold pivot, and wherein the variable length inner wing link, and not the driver, passes over a wing fold pivot axis of the wing fold pivot.

7. The foldable boom assembly of claim 1, wherein the outer wing, the inner wing, the variable length inner wing link, and the outer wing link comprises a four-bar linkage that generally maintains a diamond shape as the outer wing is displaced relative to the inner wing.

8. The foldable boom assembly of claim 1, wherein the length of the variable length inner wing link increases as the displacement of the outer wing places the foldable wing assembly in an unfolded position.

9. The foldable boom assembly of claim 8, wherein the length of the variable length inner wing link decreases as the displacement of the outer wing places the foldable wing assembly in a folded position.

10. The foldable boom assembly of claim 1, wherein the variable length inner wing link is configured to control, in at least one direction, an adjustment in the length of the variable length inner wing link.

11. The foldable boom assembly of claim 1, wherein the variable length inner wing link is an unpowered hydraulic or pneumatic cylinder.

12. A link assembly for a foldable boom assembly of an agricultural sprayer, wherein the link assembly comprises:
a driver; and
a four-bar linkage comprising:
an outer wing of a wing assembly of the foldable boom assembly;
an inner wing of the wing assembly, the inner wing being pivotally coupled to at least the outer wing at a wing fold pivot to accommodate a pivotal displacement of the outer wing relative to the inner wing about a wing fold pivot axis at the wing fold pivot;
an inner wing link, a first end of the inner wing link being pivotally coupled to at least the inner wing, the inner wing link being adjustable between a first length and a second length, the first length being larger than the second length; and
an outer wing link pivotally coupled to at least the outer wing,
wherein the inner wing link is configured to extend toward the first length in response to a first actuation by the driver that facilitates a transmission of a first force to at least a portion of the four-bar linkage that displaces the outer wing from a first position to a second position,
wherein the inner wing link is configured to collapse to the second length in response to a second actuation by the driver that facilitates a transmission of a second force to at least a portion of the four-bar linkage that displaces the outer wing from the second position to the first position,
wherein the outer wing has an angular orientation at the first position that is around 180 degrees different than the angular orientation of the outer wing at the second position, and
wherein the four-bar linkage is configured for the inner wing link, and not the driver, to cross over a center of the wing fold pivot axis as the outer wing moves between the first position and the second position.

13. The link assembly of claim 12, wherein the first length is configured to increase a length of a first moment arm of the inner wing link and a second moment arm of the driver, and wherein the inner wing link is configured to continue to extend to attain the first length while the outer wing is at the second position.

14. The link assembly of claim 12, wherein the inner wing link is configured to control an adjustment of a length of the inner wing link as the inner wing link moves toward at least one of the first length and the second length using at least one of a hydraulic fluid, a positive pressure in a chamber of the inner wing link, or a biasing element.

15. The link assembly of claim 12, wherein the driver is a fold cylinder, and wherein the first length of the inner wing link accommodates the fold cylinder attaining a full stroke.

16. A method for folding and unfolding a wing assembly for an agricultural sprayer, the method comprising:
displacing, by a first actuation of a driver, a second end of the driver from a first side of a wing fold pivot to a second side of the wing fold pivot, an outer wing and an inner wing of the wing assembly being pivotally coupled at the wing fold pivot, a first end of the driver being pivotally coupled to the inner wing;
increasing an adjustable length of an inner wing link at least as the second end of the driver is displaced to the second side of the wing fold pivot to increase a length of a first moment arm of the inner wing link and a length of a second moment arm of the driver, a first end of the inner wing link being pivotally coupled to the inner wing, a second end of the inner wing link being pivotally coupled to the second end of the driver;
pivotally displacing an outer wing link with the displacement of the second end of the driver to the second side of the wing fold pivot, a first end of the outer wing link being pivotally coupled to the outer wing and a second end of the outer wing link being pivotally coupled to the second end of the driver; and
pivotally displacing the outer wing from a first position to a second position by the first actuation of the driver, the outer wing having an angular orientation at the first position that is around 180 degrees different than the angular orientation of the outer wing at the second position.

17. The method of claim 16, further comprising:
displacing, by a second actuation of the driver, the second end of the driver from the second side to the first side of the wing fold pivot;
decreasing the adjustable length of the inner wing link at least as the second end of the driver is displaced to the first side of the wing fold pivot;
pivotally displacing the outer wing link with the displacement of the second end of the driver to the first side of the wing fold pivot; and
pivotally displacing the outer wing from the second position to the first position by the second actuation of the driver.

18. The method of claim 17, wherein increasing the adjustable length of the inner wing link further comprises moving the inner wing link, but not the driver, across a wing fold pivot axis of the wing fold pivot.

19. The method of claim 16, wherein the first position of the outer wing corresponds to a fully folded position of the wing assembly, and wherein the second position of the outer wing corresponds to a fully unfolded position of the wing assembly.

20. The method of claim 19, further comprising further increasing a length of a moment arm of the inner wing link and a length of a moment arm of the driver when the wing assembly is in the fully unfolded position.
